(19) United States
(12) Patent Application Publication
(10) Pub. No.: US 2025/0163292 A1
(43) Pub. Date: May 22, 2025

(54) METHOD FOR PRODUCING A RELEASE AGENT, A RELEASE AGENT AND USE OF THE RELEASE AGENT

(71) Applicant: LEONHARD KURZ Stiftung & Co. KG, Fürth (DE)

(72) Inventors: Mats Timothy KNOOP, Drensteinfurt (DE); Johannes LUDWIG, Fürth (DE)

(21) Appl. No.: 18/948,621

(22) Filed: Nov. 15, 2024

(30) Foreign Application Priority Data
Nov. 22, 2023 (DE) 102023132594.9

(51) Int. Cl. C09D 135/00

(52) U.S. Cl. CPC C09D 135/00

(57) ABSTRACT

A method for producing a release agent (2), wherein the method comprises at least the following steps: a) providing a reactive mixture, comprising a carboxylic-acid-containing monomer component, which comprises, preferably and/or consists of itaconic acid and/or itaconic acid derivatives; b) polymerizing the reactive mixture to form a polymer solution, wherein the polymer solution comprises a polymer which is at least partially dissolved in a solvent and which contains the carboxylic-acid-containing monomer component, c) obtaining a release agent (2) comprising the polymer solution, wherein CO₂ can be liberated from the release agent, preferably the polymer of the release agent, by decarboxylation; as well as a release agent (2) and a use of the release agent (2).

### BACKGROUND OF THE INVENTION

The invention relates to a method for producing an improved release agent, an improved release agent and the use of the release agent.

Mineral construction material mixtures, for example comprising concrete, mortar and/or sand-lime brick, are used for example in the production of buildings, in the construction of tunnels, bridges and retaining walls or foundations or of individual walls, ceilings, columns or ring beams, but also in the production of furniture or works of art.

For this, flowable or plastic mineral construction material mixtures are introduced into mold elements, preferably into formworks, which predefine the shape of a mineral molded body to be obtained therefrom. The mold elements, preferably formworks, are typically removed again after a solidification and/or hardening.

In order to achieve a nondestructive separation between the construction material mixture and the mold element, preferably the formwork, there is the possibility of arranging a release agent on at least one surface of the mold element, preferably on at least one surface of the formwork, before it is brought into contact with a flowable or plastic construction material mixture, for example wet concrete. Due to the release agent the adhesion between construction material mixture and mold element, preferably formwork, is reduced and damage to the mineral molded body and the at least one surface of the mold element, preferably the at least one surface of the formwork, is prevented.

The at least one surface of the mold element, preferably the formwork, can have been designed absorbent and/or non-absorbent, or be provided like this. The one at least one absorbent surface of the mold element, preferably of the formwork, can be based on biogenic materials, in particular wood. The at least one surface, in particular absorbent surface, can further be provided in such a way rough, in particular rough-hewn, planed, flamed and/or blasted.

Alternatively, the at least one non-absorbent surface of the mold element, preferably the formwork, can be based on metal, in particular based on steel, tempered wood, plastic, in particular tempered plastic, and/or a form liner. Further, the at least one surface, in particular non-absorbent surface, can for example be heated or unheated, and/or film-coated and/or coated with a plastic and/or rubber, or combinations thereof.

Different release agents are known from the state of the art. These can be present for example in the form of water-insoluble formwork oils, formwork pastes, formwork waxes, chemically reactive release agents or release agent emulsions. Release agents typically contain at least one oil component. By oil component is meant various substance classes or mixtures thereof. These substance classes can for example comprise mineral oils, waxes or fats and derivatives thereof. The oil component here usually forms the largest proportion, relative to the weight of the release agent before arrangement on the mold element, preferably on the formwork.

Release agents which are present in the form of an aqueous emulsion typically contain, besides the oil component, emulsifiers, for example ionic surfactants and/or nonionic surfactants, which distribute the oil component in the form of droplets in an aqueous solvent.

The release agents known from the state of the art have various disadvantages. Thus, mineral oils as oil component have an insufficient biodegradability. Additionally, release agents which contain at least one oil component or emulsifiers are typically classified as hazardous to water and thus have a low environmental compatibility.

Moreover, saponification of the oil component or emulsifiers by alkaline constituents of the mineral construction material mixture can result in unintentional precipitation of calcium soaps. This in turn leads to setting failures and structural failures of the mineral construction material mixture and results in an error pattern, which is called dusting. When the mineral construction material mixture is processed further, dusting causes adhesion problems, for example in the adhesion of paints or renders.

Further, in the case of release agents in the form of aqueous emulsions, the emulsifiers used can lead to re-emulsification at a boundary surface with alkaline mineral construction material mixtures. Here, the release agent at least partially penetrates into the surface which is formed by the mineral construction material mixture. The release agent that has penetrated can lead to problems in the adhesion of paints or renders during later further processing.

In the case of release agents which have at least one oil component, more effort is needed to clean the mineral molded body or the mold element, preferably the formwork, after demolding. This is because they can only be removed residue-free with difficulty using water. Moreover, oil components of the release agent can discolor the surface of the mineral molded body and thus influence or degrade the visual appearance in an undesired manner.

### SUMMARY OF THE INVENTION

An object of the invention now is to provide a method for producing an improved release agent, an improved release agent and the use of the improved release agent, wherein the release agent has a good environmental compatibility and good release properties.

The object is achieved by a method for producing a release agent, wherein the method comprises at least the following steps, wherein the steps are carried out in particular in the specified order:
a) providing a reactive mixture, comprising a carboxylic-acid-containing monomer component, which comprises, preferably consists of, itaconic acid and/or itaconic acid derivatives,
b) polymerizing the reactive mixture to form a polymer solution, wherein the polymer solution comprises a polymer which is at least partially dissolved in a solvent and which contains the carboxylic-acid-containing monomer component,
c) obtaining a release agent comprising the polymer solution, wherein CO₂ can be liberated from the release agent, preferably the polymer of the release agent, by decarboxylation.

The object is further achieved by a release agent, wherein the release agent contains a polymer at least partially dissolved in a solvent, wherein the polymer contains a carboxylic-acid-containing monomer component, which comprises itaconic acid and/or itaconic acid derivatives, and wherein CO₂ can be liberated from the release agent, preferably the polymer of the release agent, by decarboxylation.p

The object is further achieved through the use of a release agent, in the production of mineral molded bodies, wherein the release agent is arranged on at least one surface of a mold element, preferably on at least one surface of a formwork, and is brought into contact with a flowable or plastically deformable mineral construction material mixture, wherein the mineral construction material mixture comprises water and at least one mineral binder, and wherein CO₂ can be liberated from the release agent, preferably the polymer of the release agent, by decarboxylation.

Further, it is possible to provide a method for producing mineral molded bodies, wherein the release agent is arranged on at least one surface of a mold element, preferably on at least one surface of a formwork, which is brought into contact with a mineral construction material mixture.

The present method makes it possible to provide a release agent which contains an at least partially dissolved polymer. However, the release agent according to the invention does not require any further emulsifiers or oil components. The disadvantages already named above, which release agents can have, are avoided by dispensing with these emulsifiers or oil components in the release agent according to the invention. Moreover, any disposal costs incurred are hereby reduced.

A further advantage is that the polymer at least partially dissolved in the release agent according to the invention, in contrast to the release agents known in the state of the art, can be produced on the basis of biological raw materials. In other words, the quantity of monomers based on petroleum can be reduced. Thus, for example, the itaconic acid used as monomer can be acquired biotechnologically through the fermentation of molasses or be synthesized from pyruvic acid. This leads to a more sustainable product. Because of the availability of the raw materials, a release agent comprising the polymer can moreover be produced cost-effectively.

The polymer comprised by the release agent contains at least itaconic acid and/or itaconic acid derivatives. Due to the application of the release agent, for example through a spraying method, painting method or rolling method, a layer forms on the at least one surface of the mold element, preferably on the at least one surface of the formwork. The molecular structure of the polymer can change due to a preferably ionically catalyzed decarboxylation. Alternatively or additionally, the decarboxylation of the polymer can be thermally initiated. By decarboxylation is meant the cleavage of carbon dioxide (CO₂). In particular, the CO₂ is cleaved from the itaconic acid comprised by the polymer, in particular forming a lactone and/or cleaving a carboxylic acid.

In the following reaction equation (1) a possible reaction pathway of the decarboxylation of polyitaconic acid (left) and the resulting liberation of CO₂ (right) are shown. Through the reaction, the possible product (right) has a ring closure within the molecule:

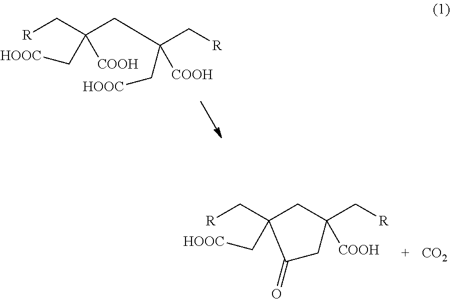

Interactions between the mineral construction material mixture and the mold element, preferably the formwork, are prevented by the release agent according to the invention. Further, the release agent leaves no or only small residues behind on the surface of the mold element, preferably on the surface of the formwork, or the mineral molded body after demolding. Any residues on the surface can be removed through the use of water alone, thus without the use of surfactants, solvents or chemical cleaners, and an ordinary cloth.

Further advantageous designs of the invention are described in the dependent claims.

The reactive mixture, which contains a carboxylic-acid-containing monomer component, is provided in step a). The carboxylic-acid-containing monomer component comprises and/or consists of itaconic acid and/or itaconic acid derivatives. Step a) is carried out at the start of the method. The composition of the constituents of the reactive mixture is chosen such that the sum of the constituents yields 100 wt.-% (wt.-%=percent by weight) relative to the total weight of the reactive material.

The carboxylic-acid-containing monomer component of the reactive mixture preferably contains and/or is provided with, besides itaconic acid and/or itaconic acid derivatives, at least one further carboxylic-acid-containing monomer component, which is selected individually or in combination from the group which consists of acrylic acid, methacrylic acid and maleic acid.

Preferred derivatives of itaconic acid of the carboxylic-acid-containing monomer component are the anhydride of itaconic acid, the methoxy ester of itaconic acid and/or ethoxy ester of itaconic acid. The itaconic acid derivative of the carboxylic-acid-containing monomer component is preferably maximally derivatized on a carboxylic acid and is present for example as itaconic acid monoester.

It is possible for the proportion of monomer of the carboxylic-acid-containing monomer component, relative to the total mass of the reactive mixture, to have been and/or to be selected from a range of from 10 wt.-% to 60 wt.-%, preferably from 20 wt.-% to 50 wt.-%, further preferably from 30 wt.-% to 40 wt.-%.

By “carboxylic-acid-containing” is preferably meant that a molecule, for example a monomer, is present which contains at least one functional unit of the —COOH type.

By “non-carboxylic-acid-containing” is preferably meant that a molecule, for example a monomer, is present which does not contain a functional unit of the —COOH type. This definition thus includes, for example besides unsaturated hydrocarbons and/or unsaturated aromatic hydrocarbons, also carboxylates and carboxylic acid derivatives for example.

By “soluble” is preferably meant that a salt or molecule, for example a monomer or a polymer, has a solubility in the solvent present of at least 60 g/l in standard atmosphere in a state of equilibrium. If a molecule has a lower solubility in standard atmosphere in a state of equilibrium, then it is understood to be “insoluble”. If the solubility is based on a solvent in the form of water, then the salt or molecule, for example a monomer or polymer, can be “water-soluble”. By “water-soluble” is thus preferably meant that a salt or molecule, for example a monomer or a polymer, has a solubility in water of at least 60 g/l in standard atmosphere in a state of equilibrium. If a molecule has a lower water solubility in standard atmosphere in a state of equilibrium, then it is understood to be “water-insoluble”. By standard atmosphere is meant a temperature of 20° C. and an air pressure of 1 bar.

It is possible for the reactive mixture to contain or to be provided with at least one non-carboxylic-acid-containing monomer component. The non-carboxylic-acid-containing monomer component is preferably selected, individually or in combination, from the group which consists of acrylamide and derivatives thereof, esters of acrylic acid, esters of methacrylic acid, esters of itaconic acid, esters of maleic acid, maleic acid anhydride, terpenes, preferably myrcene, styrene, isoprene, butadiene, vinyl ether and/or combinations thereof. The non-carboxylic-acid-containing monomer component is preferably selected from the group which consists of acrylamide and derivatives thereof, esters of acrylic acid, ester of methacrylic acid, esters of itaconic acid, terpenes or combinations thereof. The non-carboxylic-acid-containing monomer component is further preferably selected from the group which consists of acrylamide and derivatives thereof, esters of itaconic acid, terpenes or combinations thereof.

The proportion of monomer of the non-carboxylic-acid-containing monomer component, relative to the total mass of the reactive mixture, preferably has been and/or is selected from a range of from more than 0 wt.-% to 30 wt.-%, preferably from more than 0 wt.-% to 20 wt.-%, further preferably from more than 0 wt.-% to 15 wt.-%.

It is possible for at least 80 wt.-%, preferably 100 wt.-%, of the non-carboxylic-acid-containing monomer component to comprise water-soluble monomers.

It is possible for the carboxylic-acid-containing monomer component and/or the non-carboxylic-acid-containing monomer component and/or the polymer and/or the release agent to comprise and/or consist of biogenic constituents, and/or to be provided therewith.

The carboxylic-acid-containing monomer component and/or the non-carboxylic-acid-containing monomer component and/or the polymer and/or the release agent are preferably biodegradable. The carboxylic-acid-containing monomer component and/or the non-carboxylic-acid-containing monomer component and/or the polymer and/or the release agent can be compostable.

By “biodegradable” is meant the breakdown of a chemical compound or of an organic material, for example the carboxylic-acid-containing monomer component and/or the non-carboxylic-acid-containing monomer component and/or the polymer and/or the release agent, by microorganisms, for example fungi and/or bacteria, in the presence of oxygen into carbon dioxide, water and salts of other elements present (mineralization) and in particular biomass, or in the absence of oxygen into carbon dioxide, methane, mineral salts, and in particular biomass.

By “compostable” is to be meant in particular that the carboxylic-acid-containing monomer component and/or the non-carboxylic-acid-containing monomer component and/or the polymer and/or the release agent, in the case of composting by biological processes, is broken down during the composting into carbon dioxide, water, salts of other elements present and in particular biomass at a speed which matches the other known compostable materials and, in particular besides the biomass, leaves behind no visible, recognizable and/or toxic residues. In particular, the carboxylic-acid-containing monomer component and/or the non-carboxylic-acid-containing monomer component and/or the polymer and/or the release agent satisfies DIN EN 13432:2000-12 (issue date: 12.2000, “Verpackung-Anforderungen an die Verwertung von Verpackungen durch Kompostierung und biologischen Abbau—Prüfschema und Bewertungskriterien für die Einstufung von Verpackungen; German version of EN 13432:2000, Packaging-Requirements for packaging recoverable through composting and biodegradation-Test scheme and evaluation criteria for the final acceptance of packaging”) and/or the Australian standard AS 4736:2006 (issue date: 2006, “Biodegradable plastics-Biodegradable plastics suitable for composting and other microbial treatment”) and/or the US standard ASTM D6400 (issue date: 05.1999, “Standard Specification for Compostable Plastic”) and/or the ISO standard ISO17088: 2008 (issue date: 06.2012, “Specifications for compostable plastics”).

The named standards comprise a chemical test and disclosure of all ingredients. In particular, the release agent, preferably polymer, here complies with respective thresholds for heavy metals. It is additionally verifiable for the release agent, preferably polymer, that at least 90 wt.-% of the organic material is converted into CO₂ in 180 days (or at least 60 wt.-% according to ASTM D6400). Further, it is possible that not more than 10 wt.-% dry material, relative to the original initial weight, of the release agent, preferably polymer, remains after 12 weeks of composting in industrial and/or semi-industrial composting conditions and subsequent sifting through a sieve with a 2-mm mesh size. In particular, no negative effects on the composting process must occur. Finally, an ecotoxicity analysis is preferably to be carried out, wherein for a positive result no negative effect of resulting composts on plant growth compared with further composts (agronomical test) must be apparent.

It is possible for the reactive mixture to contain or to be provided with a solvent, preferably an organic solvent, which is selected individually or as mixtures from the group which consists of ethanol, 1-propanol, 2-propanol, acetone, 2-butanone (MEK), acetate, in particular ethyl acetate and lactyl acetate. The organic solvent is miscible with water in standard atmosphere, preferably miscible with water in a 1:1 ratio.

Alternatively or additionally, it is possible for the reactive mixture to contain and/or to be provided with a solvent which comprises and/or consists of water. The solvent of the reactive mixture is preferably water.

It is possible for the reactive mixture to have and/or to be provided with a pH which is selected from a range of from 3 to 14, preferably from 5 to 12, further preferably from 6 to 9. Through the above pH, the solubility of the monomer and/or of the polymer in the solvent is increased and polymerization is promoted. It is possible for the reactive mixture to comprise dissolved hydroxides of the alkali metals of main group 1 of the periodic table, preferably NaOH and/or KOH.

It is possible for the proportion of the solvent, relative to the total mass of the reactive mixture, to have been and/or to be selected from a range of from 10 wt.-% to 90 wt.-%, preferably from 30 wt.-% to 80 wt.-%, further preferably from 40 wt.-% to 60 wt.-%.

By solvent is meant a medium in which the further constituents of the reactive mixture, the polymer solution and/or the release agent are diluted. The solvent is preferably not consumed during the reaction of the constituents of the reactive mixture to form the polymer of the polymer solution. A solvent preferably has a boiling point of at most 200° C. By organic solvent is meant a solvent which has at least one carbon atom in its molecular structure.

The reactive mixture preferably contains and/or is provided with an initiator, preferably an initiator for a radical polymerization.

It is possible for the proportion of initiator, relative to the total mass of the reactive mixture, to have been and/or to be selected from a range of from 0.05 wt.-% to 2.5 wt.-%, preferably from 0.1 wt.-% to 1.5 wt.-%, further preferably from 0.5 wt.-% to 1.2 wt.-%.

The initiator preferably has been and/or is selected from the group which consists of azo compounds, peroxides or mixtures thereof.

By additive is meant a constituent which is added in order to have a defined effect and/or to give for example a mixture, material and/or solution a property, wherein the additive has a proportion of 1.5 wt.-% or less, in each case relative to the total weight of the mixture, material or solution. The initiator, the solvent, the carboxylic-acid-containing monomer component and/or the non-carboxylic-acid-containing monomer component and/or the polymer obtained therefrom are not understood as additives.

Through the use of additives, the processability of the reactive mixture, the polymer and/or the release agent can be improved. Further, the resistance of the release agent or a layer obtained therefrom to mechanical and chemical influences is increased thereby.

A reactive mixture suitable for the method according to the invention preferably has and/or is provided with the following composition, wherein the details for the individual constituents are in each case relative to the total mass of the reactive mixture and wherein the constituents are selected such that they yield 100 wt.-% in total:

| | | |
|---|---|---|
| Carboxylic-acid- | 10 | wt.-%-60 wt.-%, |
| containing monomer | | |
| component: | | |
| Non-carboxylic-acid- | 0 | wt.-%-30 wt.-%, |
| containing monomer | | |
| component: | | |
| Solvent: | 10 | wt.-%-90 wt.-%, |
| Initiator: | 0.05 | wt.-%-2.5 wt.-%, |

Further preferably:

| | | |
|---|---|---|
| Carboxylic-acid- | 20 | wt.-%-50 wt.-%, |
| containing monomer | | |
| component: | | |
| Non-carboxylic-acid- | 0 | wt.-%-20 wt.-%, |
| containing monomer | | |
| component: | | |
| Solvent: | 30 | wt.-%-80 wt.-%, |
| Initiator: | 0.1 | wt.-%-1.5 wt.-%, |

Still further preferably:

| | | |
|---|---|---|
| Carboxylic-acid- | 30 | wt.-%-40 wt.-%, |
| containing monomer | | |
| component: | | |
| Non-carboxylic-acid- | 0 | wt.-%-15 wt.-%, |
| containing monomer | | |
| component: | | |
| Solvent: | 40 | wt.-%-60 wt.-%, |
| Initiator: | 0.5 | wt.-%-1.2 wt.-%. |

In step b) a polymer solution is obtained from the reactive mixture provided in step a). The polymer solution comprises a polymer which contains at least the carboxylic-acid-containing monomer component, in particular the monomer components of the reactive mixture provided in step a). The polymer contains at least itaconic acid and/or itaconic acid derivatives as monomer unit, in particular as carboxylic-acid-containing monomer unit. Further, the polymer solution contains a solvent. The polymer is at least partially dissolved in the solvent, preferably in the form of water. It is possible for the polymer to be present dissolved in the solvent, preferably in the form of water, at a level of at least 30 g/l, preferably at least 60 g/l, in standard atmosphere in a state of equilibrium in the solvent, preferably in the form of water. Step b) is preferably carried out after step a).

It is possible for step b) to be carried out at a temperature of the reactive mixture which is selected from a range of from 20° C. to 110° C., preferably from 40° C. and 85° C., further preferably from 50° C. to 70° C.

It is possible that in step b) the solvent of the reactive mixture is separated off after the polymer has been obtained, for example selected from the group which consists of filtration, extraction by suction, evaporation, vacuum drying, exposure to IR radiation, or separation by freezing or combinations thereof. Further, it is then possible for the polymer to be added to a further solvent. In other words, it is possible for the solvent of the reactive mixture to be a different solvent from the solvent of the polymer solution.

The solvent of the polymer solution preferably comprises and/or substantially consists of water. In particular, the polymer is water-soluble.

It is possible for the polymer, in particular before the decarboxylation, to contain the carboxylic-acid-containing monomer component, preferably itaconic acid and/or itaconic acid derivatives, further preferably itaconic acid, selected from a range of from 25 wt.-% to 99.95 wt.-%, preferably from 40 wt.-% to 99.95 wt.-%, further preferably from 55 wt.-% to 99.95 wt.-%. The carboxylic-acid-containing monomer component preferably consists of itaconic acid and/or itaconic acid derivatives, preferably itaconic acid.

It is possible for the polymer, in particular before the decarboxylation, to contain the non-carboxylic-acid-containing monomer component, selected from a range of from more than 0 wt.-% to 75 wt.-%, preferably from 0 wt.-% to 60 wt.-%, further preferably from 0 wt.-% to 45 wt.-%.

In particular, the polymer, in particular before the decarboxylation, contains the initiator, selected from a range of from 0.05 wt.-% to 2 wt.-%, preferably from 0.1 wt.-% to 1.5 wt.-%, further preferably from 0.5 wt.-% to 1.1 wt.-%.

The polymer, in particular before the decarboxylation, preferably has a value for the number-average molar mass which is selected from a range of from 500 g/mol to 500,000 g/mol, preferably from 750 g/mol to 100,000 g/mol, further preferably from 1000 g/mol to 50,000 g/mol, still further preferably from 1500 g/mol to 20,000 g/mol.

It is possible for the carboxylic-acid-containing monomer component which the polymer contains to contain, besides itaconic acid and/or itaconic acid derivatives, at least one further carboxylic-acid-containing monomer component, which is selected individually or in combination from the group which consists of acrylic acid, methacrylic acid, maleic acid. The proportion of the carboxylic-acid-containing monomer component, in particular of itaconic acid and/or itaconic acid derivatives, in the polymer relative to the total mass of the polymer is in particular selected from the range of from 2.5 wt.-% to 100 wt.-%, preferably from 5 wt.-% to 80 wt.-%, further preferably from 10 wt.-% to 50 wt.-%, in particular before the decarboxylation.

The polymer preferably contains at least one non-carboxylic-acid-containing monomer component, the component or derivatives of which is selected individually or in combination from the group which consists of acrylamide, esters of acrylic acid, esters of methacrylic acid, esters of itaconic acid, esters of maleic acid, maleic acid anhydride, terpenes, myrcene, styrene, isoprene, butadiene, vinyl ethers. The proportion of the non-carboxylic-acid-containing monomer component relative to the total mass of the polymer is preferably selected from the range of from more than 0 wt.-% to 97.5 wt.-%, preferably from 5 wt.-% to 90 wt.-%, further preferably from 15 wt.-% to 85 wt.-%, in particular before the decarboxylation.

The polymer, in particular before the decarboxylation, can have a value for the glass transition temperature which is selected from a range of from −20° C. to 110° C., preferably from −20° C. to 50° C., further preferably from −10° C. to 25° C.

A release agent is obtained in step c). The release agent comprises the polymer solution, which contains the polymer obtained in step b). Before it is used, thus before it is arranged as a layer on at least one surface of a mold element, preferably on at least one surface of a formwork, the release agent, preferably the polymer, is preferably present in a state in which no decarboxylation has yet been effected and is at least partially decarboxylatable. In particular, CO₂ is liberated from the polymer of the release agent during or after the use of the release agent. Through the decarboxylation, the CO₂ is cleaved from the polymer and liberated. The quantity of polymer liberated is dependent on the polymer structure. It is possible for CO₂ to be liberated from the carboxylic-acid-containing monomer component, preferably itaconic acid and/or itaconic acid derivative, at least partially, by decarboxylation. It is possible here for the length of the polymer chains and/or the polymer mass to be reduced.

The release agent preferably liberates the CO₂ after and/or during a contact with a mineral construction material mixture. The release agent further preferably liberates the CO₂ during an at least partial solidification and/or hardening of the contacted mineral construction material mixture. The construction material mixture is in particular flowable or plastically deformable. Further, the construction material mixture contains water and at least one mineral binder. Alternatively or additionally, it is also possible for the release agent, preferably polymer, to liberate the CO₂ and/or to decarboxylate after arrangement on at least one surface of a mold element, preferably a formwork, preferably before it is brought into contact with the mineral construction material mixture.

The decarboxylation of the release agent, in particular the polymer, is preferably initiated by the contact of the release agent with a flowable or plastically deformable mineral construction material mixture.

Alternatively or additionally, the release agent can be brought into contact, preferably sprayed and/or doused, with a volume of liquid which contains the above anions and/or cations and is alkaline.

It is possible for a porous matrix of a mineral molded body to be produced, in particular as a first possible mode of action of the liberated CO₂, through the CO₂ at the contact point of the mineral construction material mixture and the surface of the mold element, preferably the formwork, on which the release agent is arranged.

It is additionally possible for the chain length and/or polymer mass of the polymer to be reduced by the decarboxylation of the polymer. It is hereby possible for in particular the water-soluble portions of the polymer to diffuse into the mineral construction material mixture. The water-soluble portions of the polymer can preferably promote the production of the porous matrix in the mineral molded body.

The porous matrix of the mineral molded body obtained has a lower strength compared with the standard strength of the mineral construction material mixture.

The adhesive force between formwork and concrete is thus lowered, with the result that the mineral molded body can be easily demolded. The standard strength or also compressive strength can be assigned to different concrete strength classes, wherein a different strength class, and from that correspondingly a different compressive strength, results depending on the requirement.

Alternatively or additionally, it is possible, in particular as a second mode of action of the liberated CO₂, that the CO₂ reacts at the surface of the mineral construction material mixture to form carbonic acid. The carbonic acid can in particular react

Ca (OH) 2 present dissolved in the liquid volume of pores of the mineral construction material mixture, wherein calcium carbonate precipitates. The above reaction is preferably called carbonation.

The above, in particular a second, mode of action can be described by the substeps which are shown in the equations (2), (3) and (4). The substeps are summarized in equation (5):

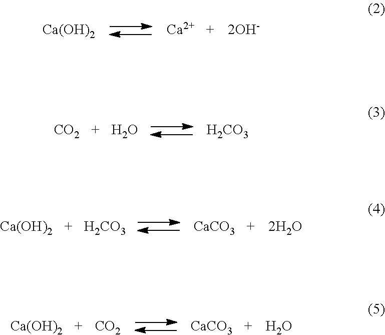

Calcium hydroxide has a larger volume compared with calcium carbonate, wherein in particular an increase in volume of 11% can result. It is hereby possible for the pore volume of the mineral construction material mixture to be reduced. Further, it is possible for a boundary surface between the surface of the mold element, preferably formwork, to be obtained which has a more uniform and/or smoother surface compared with the mineral construction material mixture before the carbonation and. In other words, a type of stone skin forms. The contact surface area between the mineral construction material mixture and the surface of the mold element, preferably the formwork, can preferably be reduced, which improves the separation of the mold element, preferably formwork, from the mineral molded body.

The active principle of the release agent is thus based in particular on the liberated CO₂. The CO₂ can produce a porous matrix in the mineral construction material mixture on the surface of the mineral construction material mixture facing the mold element as described above and/or reduce the pore volume and produce a smoother boundary surface. The release agent preferably leaves no residues behind on the surface of the mold element, preferably on the surface of the formwork. Should residues remain, these can be mechanically removed with water and an ordinary cloth. It is possible for all of the described modes of action of the liberated CO₂ to be present in the production of a mineral molded body and/or for one of the modes of action preferably to be present. For example, it is possible for the porous matrix to be obtained on the side of the smoother boundary surface facing the mold element, preferably formwork, whereby a particularly good release effect is achieved.

In particular, the flowable or plastically deformable construction material mixture comprises at least one constituent which catalyzes the decarboxylation. The decarboxylation is preferably ionically catalyzed, in particular alkalinically catalyzed. It is possible for the decarboxylation to be thermally catalyzed.

The flowable or plastically deformable construction material mixture preferably contains divalent or polyvalent cations of at least one metal, wherein the at least one metal is preferably selected from the group which consists of Mg, Ca, Sr, Ba, Al, Fe, Co, or mixtures thereof. The cations are preferably present in the form of water-soluble salts.

The inventors have surprisingly found that in the presence of divalent or polyvalent cations the decarboxylation and the liberation of CO₂ can be carried out particularly well. Di- or polyvalent cations can preferably catalyze the decarboxylation of the polymer, preferably of the itaconic acid and/or itaconic acid derivatives. The presence of alkali metals of main group 1 of the periodic table, such as sodium or potassium, as well as other monovalent ions, such as ammonium, for example in an alkaline solution, have no significant influence on the decarboxylation. It is possible for corresponding salts of itaconic acid to form which have a higher water solubility compared with itaconic acid. In other words, the release agent is stable with respect to alkali metals of main group 1 of the periodic table, since these do not initiate a decarboxylation.

By “alkaline” is preferably meant that the flowable or plastically deformable mineral construction material mixture and/or a solution has a pH selected from a range of from 8 to 14, preferably from 10 to 14, further preferably from 12 to 14.

The mineral construction material mixture preferably comprises or consists of concrete, mortar, sand-lime brick, silicate ceramic or a combination thereof. The at least one mineral binder preferably comprises a hydraulic binder, a non-hydraulic binder or a mixture thereof. Further, it is possible for the at least one mineral binder to be selected from the group which consists of calcium silicate hydrates, cement, lime, clay, gypsum, brickearth, magnesia binder and combinations thereof.

A method for producing a mineral molded body in which the release agent can be used has at least the following substeps, which are carried out in particular in the specified order:
i) providing at least one mold element, preferably a formwork, with at least one surface on which the release agent according to the invention and/or the release agent obtained in step c) according to the method according to the invention is arranged in the form of a layer,
ii) applying a flowable or plastically deformable, mineral construction material mixture which comprises water and at least one mineral binder to the at least one surface of the mold element, preferably the formwork, coated with the release agent,
iii) at least partially solidifying the mineral construction material mixture, to obtain a dimensionally stable, mineral green body, and hardening the mineral construction material mixture, preferably the dimensionally stable, mineral green body,
iv) removing the mold element, preferably the formwork, from the mineral construction material mixture and obtaining a mineral molded body.

The release agent preferably cleaves CO₂ from the polymer structure after step i), in step ii) and/or in step iii).

The release agent is preferably arranged on the at least one surface of the mold element, preferably on the at least one surface of the formwork, through a method which is selected from the group which consists of spraying methods, painting methods or rolling methods or combinations thereof. The release agent is preferably arranged on the at least one surface of the mold element, preferably on the at least one surface of the formwork, over the whole surface. The release agent is preferably arranged on all surfaces of the mold element, preferably on the at least one surface of the formwork, which are brought into contact with the mineral construction material mixture, over the whole surface.

The quantity of the release agent deposited is preferably selected from a range of from 50 g/m² to 400 g/m², preferably from 100 g/m² to 250 g/m², further preferably from 125 g/m² to 175 g/m², relative to a non-absorbent formwork.

The release agent can act as a release agent, i.e. has a releasing effect, in the form of a layer independently of a moisture content of the release agent. In other words, the decarboxylation of the release agent, preferably polymer, can be effected independently of the moisture content of the release agent and/or the CO₂ can be liberated from the release agent, preferably polymer, independently of the moisture content. The release agent can hereby act both in the dry state and in the moist state.

By the dry state is meant a dry layer, preferably after arrangement, which preferably comprises a proportion of constituents which have a boiling point lower than 110° C. selected from a range of from 0 wt.-% to 10 wt.-%, preferably from 0 wt.-% to 8 wt.-%, further preferably from 0 wt.-% to 5 wt.-%, relative to the total mass of the constituents of the layer. A drying is preferably carried out until the constituents of the layer have a constant mass. By the moist state is meant the release agent before use, preferably such as is provided in step c), wherein the release agent contains the polymer solution.

The release agent preferably contains or is provided with an indicator, whereby the release agent in the dry state has a different color impression compared with the moist state.

The release agent before use, comprising the polymer solution, thus has a different color impression compared with a dry layer. For example, it is possible for the indicator to have a color impression in the moist state of the release agent and for the indicator to be colorless in the dry state of the release agent. In the dry state the indicator is thus preferably not recognizable for an observer.

A suitable indicator is preferably selected from one or more leuco dyes.

The indicator provides the advantage that, when the layer is arranged on the at least one surface of the mold element, preferably on the at least one surface of the formwork, it is possible to recognize where the release agent has already been arranged. A particularly uniform depositing can hereby be made possible.

It is possible for the release agent to comprise and/or be provided with a flow additive, preferably selected from a range of from more than 0 wt.-% to 10 wt.-%, further preferably from more than 0 wt.-% to 7.5 wt.-%, still further preferably from more than 0 wt.-% to 5.5 wt.-%, in each case relative to the total weight of the release agent. The flow additive makes it possible to form uniform films and layers.

By the total weight of the release agent is meant the moist state and/or the total weight of the release agent with which the release agent is obtained in step c) and before it is used.

It is also possible for the release agent to comprise and/or be provided with a thickener, preferably selected from a range of from more than 0 wt.-% to 2 wt.-%, further preferably from more than 0 wt.-% to 1.5 wt.-%, still further preferably from more than 0 wt.-% to 1.2 wt.-%, in each case relative to the total weight of the release agent. The thickener makes a uniform layer thickness of the layer possible even on vertical surfaces.

The release agent from step c) contains the polymer solution from step b). The release agent preferably comprises the polymer solution selected from a range of from 0.01 wt.-% to 100 wt.-%, preferably from 0.01 wt.-% to 50 wt.-%, further preferably from 0.01 wt.-% to 20 wt.-%, and/or is provided like this, in each case relative to the total weight of the release agent.

The release agent from step c) contains in particular the polymer solution from step b). In a preferred embodiment the polymer solution preferably comprises the polymer selected from a range of from 0.005 wt.-% to 50 wt.-%, preferably from 0.005 wt.-% to 25 wt.-%, further preferably from 0.005 wt.-% to 10 wt.-%, and/or is provided like this, in each case relative to the total weight of the release agent.

The solvent the release agent preferably comprises and/or substantially consists of water.

The release agent preferably contains and/or is provided with solvent, preferably in the form of water, selected from a range of from more than 0 wt.-% to 99.99 wt.-%, preferably from 50 wt.-% to 99.99 wt.-%, further preferably from 80 wt.-% to 99.99 wt.-%, in each case relative to the total weight of the release agent.

A release agent according to the invention preferably has and/or is provided with the following composition, wherein the details for the individual constituents are in each case relative to the total weight of the release agent and/or with which it is provided, and wherein the constituents are selected such that in total they yield 100 wt.-%:

| | | |
|---|---|---|
| Polymer solution: | 0.01 | wt.-%-100 wt.-%, |
| Solvent: | 0 | wt.-%-99.99 wt.-%, |
| Flow additive: | 0 | wt.-%-10 wt.-%, |
| Thickener: | 0 | wt.-%-2 wt.-%, |

Further preferably:

| | | |
|---|---|---|
| Polymer solution: | 0.01 | wt.-%-50 wt.-%, |
| Solvent: | 50 | wt.-%-99.99 wt.-%, |
| Flow additive: | 0 | wt.-%-7.5 wt.-%, |
| Thickener: | 0 | wt.-%-1.5 wt.-%, |

Still further preferably:

| | | |
|---|---|---|
| Polymer solution: | 0.01 | wt.-%-20 wt.-%, |
| Solvent: | 80 | wt.-%-99.99 wt.-%, |
| Flow additive: | 0 | wt.-%-5.5 wt.-%, |
| Thickener: | 0 | wt.-%-1.2 wt.-%. |

The dynamic viscosity has been and/or is preferably selected from a range of from 1 mPas to 300 Pas, preferably from 2 mPas to 200 mPas, further preferably from 3 mPas to 150 mPas, still further preferably from 3 mPas to 100 mPas.

In particular in the case of arrangement on a vertical surface, the release agent has a dynamic viscosity which is selected from a range of from 50 mPas to 300 mPas, preferably from 75 mPas to 200 mPas, further preferably from 100 mPas to 150 mPas.

In particular in the case of application to a horizontal surface, the release agent has a dynamic viscosity which is selected from a range of from 1 mPas to 300 mPas, preferably from 2 mPas to 200 mPas, further preferably from 3 mPas to 100 mPas.

The dynamic viscosity is preferably determined in each case according to the method of viscosity determination by means of rotary viscometers described in DIN EN ISO 2884-1:2006-09 (issue date: 2006-09, “Beschichtungsstoffe—Bestimmung der Viskosität mit Rotationsviskosimetern—Teil 1: Kegel-Platte-Viskosimeter bei hohem Geschwindigkeitsgefälle (ISO 2884-1:1999); German version of EN ISO 2884-1:2006, Paints and varnishes—Determination of viscosity using rotary viscometers—Part 1: Cone-and-plate viscometer operated at a high rate of shear”), in particular using a cone-and-plate viscometer from Thermo Scientific, Haake Mars 60 model with a cone-and-plate measuring geometry.

The cone-and-plate viscometer is a measuring device for determining viscosity, in particular dynamic viscosity, and substantially consists of a measuring head and a stationary holder for a medium to be measured. Moreover, an upper temperature-control module and a measuring axle, for receiving a rotor, are located in the measuring head, wherein the rotor is formed for receiving different cone-plates. A cone-plate is substantially a round measuring plate in the center of which a small peak is arranged. The cone diameter is normally 24 mm with a cone angle of 0.5° (+/−2′), in particular from the peak to the measuring plate. Furthermore, a lower temperature-control module is located in the stationary holder. The upper and lower temperature-control modules ensure that the rotor and the medium to be measured have the same temperature. The medium to be measured is introduced into the stationary holder. The stationary holder can have a plate. The cone-plate rests on the medium, forming a certain clearance, and can thus move freely in the medium. By the clearance is meant the distance from the peak of the cone-plate to the lower stationary holder. Cone-and-plate viscometers operate with an electric motor, which drives the cone-plate at a constant rotational speed, such that its peak touches a rigid temperature-controlled plate. The torque can be measured mechanically or electronically. Cone-and-plate viscometers are often used for the routine measurement of viscosity at a high rate of shear. The device is designed such that the unit which consists of cone-plate and motor can be easily raised, first when the test liquid is placed on the plate and later in order to make a thorough cleaning possible after each measurement. When the liquid, preferably the medium to be measured, is used, it only fills the small gap between the plate and the cone. The cone-and-plate viscometer preferably operates at a rotational speed of 750 rpm (+/−rpm) in a viscosity range of from 0 Pas to 1 Pas. The medium to be measured is preferably tested at a shear rate of from 9000 s⁻¹ to 12,000 s⁻¹. Specifically, a shear rate of 9000 s⁻¹ results from the above-named details. The rate of shear must be the same when the viscosities of paints and varnishes are compared. Unless otherwise agreed, the determination must in particular be carried out at (23±0.2° C.) The value obtained provides information about the resistance of the substance, in particular of the release agent, when deposited by painting, spraying and rolling.

After the at least partial solidification and/or hardening of the mineral molded body, the surface of the mineral molded body brought into contact with the release agent is preferably designed such that the surface area of shrink holes, relative to the total surface area, is less than 5%, preferably less than 3%, particularly preferably less than 1.5%.

A mineral molded body is evaluated as at least partially solidified when it has reached at least 50% of its standard strength. A mineral molded body, for example based on cement paste, preferably solidifies over a period of twelve hours. A mineral molded body is preferably at least partially hardened when it has reached 95% of its standard strength. The curing of concrete is effected over several days. A conversion from cement paste to cement stone takes place for example in concrete or mortar in the curing phase. In normal temperature and moisture conditions, cement preferably reaches the standard strength after 28 days.

By shrink holes is meant holes, air pockets and/or defects in the surface of the mineral molded body, preferably when viewed perpendicular to the plane formed by the molded body surface. Shrink holes can form for example by the release agent being deposited too thickly or by the release agent penetrating into the molded body.

A sought molded body surface is characterized in that there are as few shrink holes as possible and/or the shrink holes are as small as possible. The number and size of the shrink holes can be regarded and analyzed as a quality indicator for the molded body surface.

The determination of the above surface area of shrink holes is carried out as follows. A mold element, preferably a formwork, is provided in the form of a plastic cube with an edge length of 150 mm. The release agent is arranged and then dried on the surfaces of the mold element, preferably on the surfaces of the formwork, with a spray gun and an application weight of 150 g/m².

As mineral construction material mixture, 1935 g gravel (grain-size fraction: from 2 mm to 8 mm), 2565 g sand (grain-size fraction: from 0 mm to 2 mm) and 900 g CEM II/A-LL 42.5 N (Portland limestone cement) are mixed with each other and this mixture is stirred with 450 g water to form a homogeneous concrete mixture.

The concrete is then poured into the mold element, preferably into the formwork. The fill level is preferably at least 9 cm. The side parts, i.e. the vertical surfaces of the mineral molded body, but not the bottom side, i.e. the horizontal surface, of the mineral molded body are used for the analysis.

In order to ascertain the size and number of shrink holes, the image-processing program Fiji (Version ImageJ 1.53c) is used. In a first step an image is taken of the surface area to be analyzed. The photographed surface area is preferably at least 15 cm×9 cm. An internal partial surface area is then created from the photographed surface area, by removing at least 2 cm at least at each edge of the photographed surface area in each case starting from the edge. Edge effects, such as for example spalling or shrink holes situated at the edge, are hereby excluded from the analysis. The internal partial surface area is preferably at least 7 cm×7 cm.

First of all, a binary color image is created of the internal partial surface area in the image-processing program. The color values of the image are then set such that the closed surface area, i.e. the surface area free of shrink holes, is monochromatic and the shrink holes are represented colorless. Area proportions of the colorless portions, thus the total surface area of all shrink holes, are then ascertained by the image-processing program. The surface area of the shrink holes is relative to the total surface area, preferably to the internal partial surface area, and is given in percent.

The release agent contains in particular no polychlorinated biphenyls. The release agent contains no dispersion additive and/or emulsion additive, and/or is provided without these. It is possible for the polymer to have an emulsifying effect.

The release agent contains no refined oils and/or fats, biogenic oils and/or fats and/or is provided without these. The carboxylic-acid-containing monomer component and optionally the non-carboxylic-acid-containing monomer component from step a), as well as the polymer obtained polymer in step b), are not understood as refined oils and/or fats, biogenic oils and/or fats.

Of course, the above-listed article features can also be applied in an equivalent way in a method, or listed method features can be applied in a product.

### BRIEF DESCRIPTION OF THE DRAWINGS

The invention is explained by way of example in the following with reference to several embodiment examples with the aid of the accompanying drawings. The embodiment examples shown are therefore not to be understood as limitative.

FIG. 1 shows, schematically, the method for producing a release agent

FIG. 2 shows a schematic representation of the use of the release agent.

### DETAILED DESCRIPTION

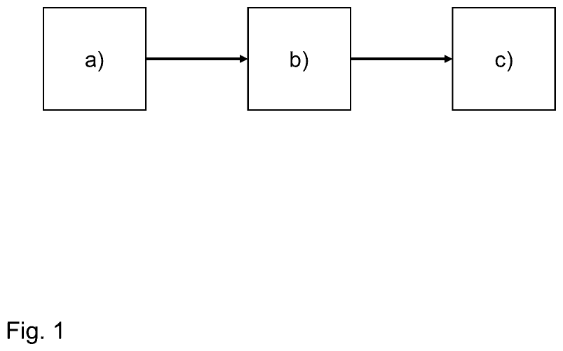

FIG. 1 shows, schematically, a method for producing the release agent 2 according to the invention. The method has at least the following steps a), b) and c).

In step a) of FIG. 1 the reactive mixture is provided, which contains a carboxylic-acid-containing monomer component, wherein this carboxylic-acid-containing monomer component comprises and/or consists of itaconic acid and/or itaconic acid derivatives. Step a) is carried out at the start of the method. The composition of the constituents of the reactive mixture is chosen such that the sum of the constituents yields 100 wt.-% (wt.-%=percent by weight) relative to the total weight of the reactive material.

The carboxylic-acid-containing monomer component of the reactive mixture according to FIG. 1 preferably contains and/or is provided with, besides itaconic acid and/or itaconic acid derivatives, at least one further carboxylic-acid-containing monomer component, which is selected individually or in combination from the group which consists of acrylic acid, methacrylic acid and maleic acid.

Preferred derivatives of the itaconic acid of the carboxylic-acid-containing monomer component are the anhydride of itaconic acid, the methoxy ester of itaconic acid and/or ethoxy ester of itaconic acid. The itaconic acid derivative of the carboxylic-acid-containing monomer component is preferably maximally derivatized on a carboxylic acid and is present for example as itaconic acid monoester.

It is possible for the proportion of monomer of the carboxylic-acid-containing monomer component, relative to the total mass of the reactive mixture, to have been and/or to be selected from a range of from 10 wt.-% to 60 wt.-%, preferably from 20 wt.-% to 50 wt.-%, further preferably from 30 wt.-% to 40 wt.-%.

It is possible for the reactive mixture according to the method of FIG. 1 to contain or to be provided with at least one non-carboxylic-acid-containing monomer component which is selected individually or in combination from the group which consists of acrylamide and derivatives thereof, esters of acrylic acid, esters of methacrylic acid, esters of itaconic acid, esters of maleic acid, maleic acid anhydride, terpenes, preferably myrcene, styrene, isoprene, butadiene, vinyl ether and/or combinations thereof. The non-carboxylic-acid-containing monomer component is preferably selected from the group which consists of acrylamide and derivatives thereof, esters of acrylic acid, ester of methacrylic acid, esters of itaconic acid, terpenes or combinations thereof. The non-carboxylic-acid-containing monomer component is further preferably selected from the group which consists of acrylamide and derivatives thereof, esters of itaconic acid, terpenes or combinations thereof.

The proportion of monomer of the non-carboxylic-acid-containing monomer component, relative to the total mass of the reactive mixture, has been and/or is preferably selected from a range of from more than 0 wt.-% to 30 wt.-%, preferably from more than 0 wt.-% to 20 wt.-%, further preferably from more than 0 wt.-% to 15 wt.-%.

It is possible for at least 80 wt.-%, preferably 100 wt.-%, of the non-carboxylic-acid-containing monomer component to comprise water-soluble monomers.

It is possible for the carboxylic-acid-containing monomer component and/or the non-carboxylic-acid-containing monomer component and/or the polymer and/or the release agent 2 to comprise and/or consist of biogenic constituents, and/or to be provided therewith.

The carboxylic-acid-containing monomer component and/or the non-carboxylic-acid-containing monomer component and/or the polymer and/or the release agent 2 are preferably biodegradable. The carboxylic-acid-containing monomer component and/or the non-carboxylic-acid-containing monomer component and/or the polymer and/or the release agent 2 can be compostable.

It is possible for the reactive mixture according to the method of FIG. 1 to contain or to be provided with a solvent, preferably an organic solvent, which is selected individually or as mixtures from the group which consists of ethanol, 1-propanol, 2-propanol, acetone, 2-butanone (MEK), acetate, in particular ethyl acetate and lactyl acetate. The organic solvent is miscible with water in standard atmosphere, preferably miscible with water in a 1:1 ratio.

Alternatively or additionally, it is possible for the reactive mixture to contain and/or to be provided with a solvent which comprises and/or consists of water. The solvent of the reactive mixture is preferably water.

It is possible for the reactive mixture to have and/or to be provided with a pH which is selected from a range of from 3 to 14, preferably from 5 to 12, further preferably from 6 to 9. It is possible for the reactive mixture to comprise dissolved hydroxides of the alkali metals of main group 1 of the periodic table, preferably NaOH and/or KOH.

It is possible for the proportion of the solvent, relative to the total mass of the reactive mixture, to have been and/or to be selected from a range of from 10 wt.-% to 90 wt.-%, preferably from 30 wt.-% to 80 wt.-%, further preferably from 40 wt.-% to 60 wt.-%.

The reactive mixture according to the method according to FIG. 1 preferably contains and/or is provided with an initiator, preferably an initiator for a radical polymerization.

It is possible for the proportion of initiator, relative to the total mass of the reactive mixture, to have been and/or to be selected from a range of from 0.05 wt.-% to 2.5 wt.-%, preferably from 0.1 wt.-% to 1.5 wt.-%, further preferably from 0.5 wt.-% to 1.2 wt.-%.

The initiator preferably has been and/or is selected from the group which consists of azo compounds, peroxides or mixtures thereof.

The reactive mixture according to the method of FIG. 1 preferably has and/or is provided with the following composition, wherein the details for the individual constituents are in each case relative to the total mass of the reactive mixture and wherein the constituents are selected such that they yield 100 wt.-% in total:

| | | |
|---|---|---|
| Carboxylic-acid- | 10 | wt.-%-60 wt.-%, |
| containing monomer | | |
| component: | | |
| Non-carboxylic-acid- | 0 | wt.-%-30 wt.-%, |
| containing monomer | | |
| component: | | |
| Solvent: | 10 | wt.-%-90 wt.-%, |
| Initiator: | 0.05 | wt.-%-2.5 wt.-%, |

Further preferably:

| | | |
|---|---|---|
| Carboxylic-acid- | 20 | wt.-%-50 wt.-%, |
| containing monomer | | |
| component: | | |
| Non-carboxylic-acid- | 0 | wt.-%-20 wt.-%, |
| containing monomer | | |
| component: | | |
| Solvent: | 30 | wt.-%-80 wt.-%, |
| Initiator: | 0.1 | wt.-%-1.5 wt.-%, |

Still further preferably:

| | | |
|---|---|---|
| Carboxylic-acid- | 30 | wt.-%-40 wt.-%, |
| containing monomer | | |
| component: | | |
| Non-carboxylic-acid- | 0 | wt.-%-15 wt.-%, |
| containing monomer | | |
| component: | | |
| Solvent: | 40 | wt.-%-60 wt.-%, |
| Initiator: | 0.5 | wt.-%-1.2 wt.-%. |

In step b) according to the method according to FIG. 1, a polymer solution is obtained from the reactive mixture provided in step a). The polymer solution comprises a polymer which contains at least the carboxylic-acid-containing monomer component, in particular the monomer components of the reactive mixture provided in step a). Further, the polymer solution contains a solvent. The polymer is at least partially dissolved in the solvent, preferably in the form of water. It is possible for the polymer to be present dissolved in the solvent, preferably in the form of water, at a level of at least 30 g/l, preferably at least 60 g/l, in standard atmosphere in a state of equilibrium in the solvent, preferably in the form of water. Step b) is preferably carried out after step a).

It is possible for step b) to be carried out at a temperature of the reactive mixture which is selected from a range of from 20° C. to 110° C., preferably from 40° C. and 85° C., further preferably from 50° C. to 70° C.

It is possible that in step b) according to the method according to FIG. 1 the solvent of the reactive mixture is separated off after the polymer has been obtained, for example selected from the group which consists of filtration, extraction by suction, evaporation, vacuum drying, exposure to IR radiation, or separation by freezing or combinations thereof. Further, it is then possible for the polymer to be added to a further solvent. In other words, it is possible for the solvent of the reactive mixture to be a different solvent from the solvent of the polymer solution.

It is additionally possible that in step b) the polymer is washed with a further, preferably organic solvent which has a lower boiling point than the solvent which has been and/or is comprised by the reactive mixture.

The solvent of the polymer solution preferably comprises and/or substantially consists of water. In particular, the polymer is water-soluble.

It is possible for the polymer, in particular before the decarboxylation, to contain the carboxylic-acid-containing monomer component, preferably itaconic acid and/or itaconic acid derivatives, further preferably itaconic acid, selected from a range of from 25 wt.-% to 99.95 wt.-%, preferably from 40 wt.-% to 99.95 wt.-%, further preferably from 55 wt.-% to 99.95 wt.-%. The carboxylic-acid-containing monomer component preferably consists of itaconic acid and/or itaconic acid derivatives, preferably itaconic acid.

It is possible for the polymer, in particular before the decarboxylation, to contain the non-carboxylic-acid-containing monomer component, in particular selected from a range of from more than 0 wt.-% to 75 wt.-%, preferably from more than 0 wt.-% to 60 wt.-%, further preferably from more than 0 wt.-% to 45 wt.-%.

In particular, the polymer, in particular before the decarboxylation, contains the initiator, selected from a range of from 0.05 wt.-% to 2 wt.-%, preferably from 0.1 wt.-% to 1.5 wt.-%, further preferably from 0.5 wt.-% to 1.1 wt.-%.

The polymer, in particular before the decarboxylation, preferably has a value for the number-average molar mass which is selected from a range of from 500 g/mol to 500,000 g/mol, preferably from 750 g/mol to 100,000 g/mol, further preferably from 1000 g/mol to 50,000 g/mol, still further preferably from 1500 g/mol to 20,000 g/mol.

It is possible for the carboxylic-acid-containing monomer component which the polymer contains to contain, besides itaconic acid and/or itaconic acid derivatives, at least one further carboxylic-acid-containing monomer component which is selected individually or in combination from the group which consists of acrylic acid, methacrylic acid, maleic acid. The proportion of the carboxylic-acid-containing monomer component, in particular of itaconic acid and/or itaconic acid derivatives, in the polymer relative to the total mass of the polymer is in particular selected from the range of from 2.5 wt.-% to 100 wt.-%, preferably from 5 wt.-% to 80 wt.-%, further preferably from 10 wt.-% to 50 wt.-%, in particular before the decarboxylation.

The polymer preferably contains at least one non-carboxylic-acid-containing monomer component, the component or derivatives of which is selected individually or in combination from the group which consists of acrylamide, esters of acrylic acid, esters of methacrylic acid, ester of itaconic acid, ester of maleic acid, maleic acid anhydride, terpenes, myrcene, styrene, isoprene, butadiene, vinyl ethers. The proportion of the non-carboxylic-acid-containing monomer component relative to the total mass of the polymer is preferably selected from the range of from more than 0 wt.-% to 97.5 wt.-%, preferably from 5 wt.-% to 90 wt.-%, further preferably from 15 wt.-% to 85 wt.-%, in particular before the decarboxylation.

The polymer, in particular before the decarboxylation, can have a value for the glass transition temperature which is selected from a range of from −20° C. to 110° C., preferably from −20° C. to 50° C., further preferably from −10° C. to 25° C.

A release agent 2 is obtained in step c) according to the method according to FIG. 1. The release agent 2 comprises the polymer solution which contains the polymer obtained in step b). Before it is used, thus before it is arranged as a layer on at least one surface of a mold element 1, preferably on at least one surface of a formwork, the release agent 2, preferably the polymer, is preferably present in a state in which no decarboxylation has yet been effected and is at least partially decarboxylatable. In particular, CO₂ is liberated from the polymer of the release agent 2 during or after the use of the release agent 2. Through the decarboxylation, the CO₂ is cleaved from the polymer and liberated. The quantity of polymer liberated is dependent on the polymer structure. It is possible for CO₂ to be liberated from the carboxylic-acid-containing monomer component, preferably itaconic acid and/or itaconic acid derivative, at least partially, by decarboxylation.

The release agent 2 preferably liberates the CO₂ after and/or during a contact with a mineral construction material mixture 3. The release agent 2 further preferably liberates the CO₂ during an at least partial solidification and/or hardening of the contacted mineral construction material mixture 3. The construction material mixture 3 is in particular flowable or plastically deformable. Further, the construction material mixture 3 contains water and at least one mineral binder. Alternatively or additionally, it is also possible for the release agent 2, preferably polymer, to liberate the CO₂ and/or to decarboxylate after arrangement on at least one surface of a mold element 1, preferably a formwork, preferably before it is brought into contact with the mineral construction material mixture 3.

The release agent 2 can act as a release agent 2 in the form of a layer independently of a moisture content of the release agent 2. In other words, the decarboxylation of the release agent 2, preferably polymer, can be effected independently of the moisture content of the release agent 2 and/or the CO₂ can be liberated from the release agent 2, preferably polymer, independently of the moisture content. The release agent 2 can hereby act both in the dry state and in the moist state.

The release agent 2 preferably contains or is provided with an indicator, whereby the release agent 2 in the dry state has a different color impression compared with the moist state. The release agent 2 before use, comprising the polymer solution, thus has a different color impression compared with a dry layer.

For example, it is possible for the indicator to have a color impression in the moist state of the release agent 2 and for the indicator to be colorless in the dry state of the release agent 2. In the dry state the indicator is thus preferably not recognizable for an observer.

A suitable indicator is preferably selected from one or more leuco dyes.

It is possible for the release agent 2 to comprise and/or be provided with a flow additive, preferably selected from a range of from more than 0 wt.-% to 10 wt.-%, further preferably from more than 0 wt.-% to 7.5 wt.-%, still further preferably from more than 0 wt.-% to 5.5 wt.-%, in each case relative to the total weight of the release agent 2.

By the total weight of the release agent 2 is meant the moist state and/or the total weight of the release agent 2 with which the release agent is obtained in step c) and before it is used.

It is also possible for the release agent 2 to comprise and/or be provided with a thickener, preferably selected from a range of from more than 0 wt.-% to 2 wt.-%, further preferably from more than 0 wt.-% to 1.5 wt.-%, still further preferably from more than 0 wt.-% to 1.2 wt.-%, in each case relative to the total weight of the release agent 2.

The release agent 2 from step c) contains the polymer solution from step b). The release agent 2 preferably comprises the polymer solution selected from a range of from 0.01 wt.-% to 100 wt.-%, preferably from 0.01 wt.-% to 50 wt.-%, further preferably from 0.01 wt.-% to 20 wt.-%, and/or is provided like this, in each case relative to the total weight of the release agent 2.

The release agent 2 from step c) contains in particular the polymer solution from step b). In a preferred embodiment, the polymer solution preferably comprises the polymer selected from a range of from 0.005 wt.-% to 50 wt.-%, preferably from 0.005 wt.-% to 25 wt.-%, further preferably from 0.005 wt.-% to 10 wt.-%, and/or is provided like this, in each case relative to the total weight of the release agent 2.

The solvent of the release agent 2 preferably comprises and/or substantially consists of water.

The release agent 2 according to the method according to FIG. 1 preferably contains and/or is provided with solvent, preferably in the form of water, selected from a range of from more than 0 wt.-% to 99.99 wt.-%, preferably from 50 wt.-% to 99.99 wt.-%, further preferably from 80 wt.-% to 99.99 wt.-%, in each case relative to the total weight of the release agent 2.

A release agent 2 according to the invention preferably has and/or is provided with the following composition, wherein the details for the individual constituents are in each case relative to the total weight of the release agent 2 and/or with which it is provided, and wherein the constituents are selected such that they yield 100 wt.-% in total:

| | | |
|---|---|---|
| Polymer solution: | 0.01 | wt.-%-100 wt.-%, |
| Solvent: | 0 | wt.-%-99.99 wt.-%, |
| Flow additive: | 0 | wt.-%-10 wt.-%, |
| Thickener: | 0 | wt.-%-2 wt.-%, |

Further preferably:

| | | |
|---|---|---|
| Polymer solution: | 0.01 | wt.-%-50 wt.-%, |
| Solvent: | 50 | wt.-%-99.99 wt.-%, |
| Flow additive: | 0 | wt.-%-7.5 wt.-%, |
| Thickener: | 0 | wt.-%-1.5 wt.-%, |

Still further preferably:

| | | |
|---|---|---|
| Polymer solution: | 0.01 | wt.-%-20 wt.-%, |
| Solvent: | 80 | wt.-%-99.99 wt.-%, |
| Flow additive: | 0 | wt.-%-5.5 wt.-%, |
| Thickener: | 0 | wt.-%-1.2 wt.-%. |

The dynamic viscosity has been and/or is preferably selected from a range of from 1 mPas to 300 Pas, preferably from 2 mPas to 200 mPas, further preferably from 3 mPas to 150 mPas, still further preferably from 3 mPas to 100 mPas.

In particular in the case of arrangement on a vertical surface, the release agent 2 has a dynamic viscosity which is selected from a range of from 50 mPas to 300 mPas, preferably from 75 mPas to 200 mPas, further preferably from 100 mPas to 150 mPas.

In particular in the case of application to a horizontal surface, the release agent 2 has a dynamic viscosity which is selected from a range of from 1 mPas to 300 mPas, preferably from 2 mPas to 200 mPas, further preferably from 3 mPas to 100 mPas.

The dynamic viscosity is preferably determined in each case according to the method of viscosity determination by means of rotary viscometers described in DIN EN ISO 2884-1:2006-09 (issue date: 2006-09, “Beschichtungsstoffe—Bestimmung der Viskosität mit Rotationsviskosimetern—Teil 1: Kegel-Platte-Viskosimeter bei hohem Geschwindigkeitsgefälle (ISO 2884-1:1999); German version of EN ISO 2884-1:2006, Paints and varnishes—Determination of viscosity using rotary viscometers—Part 1: Cone-and-plate viscometer operated at a high rate of shear”), in particular using a cone-and-plate viscometer from Thermo Scientific, Haake Mars 60 model with a cone-and-plate measuring geometry.

After the at least partial solidification and/or hardening of the mineral molded body 4, the surface of the mineral molded body 4 brought into contact with the release agent 2 is preferably designed such that the surface area of shrink holes, relative to the total surface area, is less than 5%, preferably less than 3%, particularly preferably less than 1.5%.

The release agent 2 contains in particular no polychlorinated biphenyls. The release agent 2 contains no dispersion additive and/or emulsion additive, and/or is provided without these. It is possible for the polymer to have an emulsifying effect.

The release agent 2 contains no refined oils and/or fats, biogenic oils and/or fats and/or is provided without these. The carboxylic-acid-containing monomer component and optionally the non-carboxylic-acid-containing monomer component from step a), as well as the polymer obtained polymer in step b), are not understood to be refined oils and/or fats, biogenic oils and/or fats.

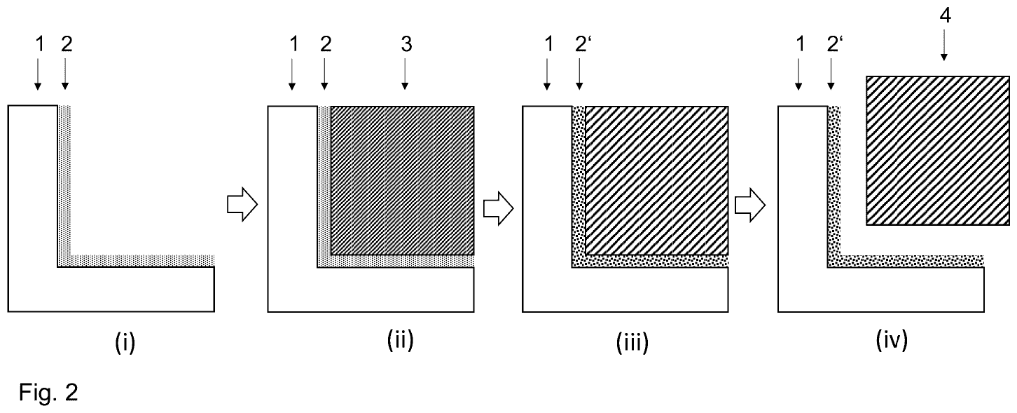

FIG. 2 shows a schematic representation of the use of the release agent 2 according to the invention or of the release agent 2 which is produced according to claim 1 in a method by means of which a mineral molded body 4 is obtained.

At least one mold element 1, preferably a formwork, is provided in step i). The release agent 2 according to the invention or the release agent 2 obtained according to the method according to the invention in step c) is arranged in the form of a layer on at least one surface of the mold element 1, preferably the formwork.

The release agent 2 is preferably arranged on the at least one surface of the mold element 1, preferably on the at least one surface of the formwork, through a method which is selected from the group which consists of spraying methods, painting methods or rolling methods or combinations thereof. The release agent 2 is preferably arranged on the at least one surface of the mold element 1, preferably on the at least one surface of the formwork, over the whole surface. The release agent 2 is preferably arranged on all surfaces of the mold element 1, preferably on the at least one surface of the formwork, which are brought into contact with the mineral construction material mixture 3, over the whole surface.

The quantity of the release agent 2 deposited is preferably selected from a range of from 50 g/m² to 400 g/m², preferably from 100 g/m² to 250 g/m², further preferably from 125 g/m² to 175 g/m², relative to a non-absorbent formwork.

In step ii) an in particular flowable or plastically deformable mineral construction material mixture 3 which comprises water and at least one mineral binder is then arranged on the at least one surface of the mold element 1, preferably the formwork, coated with the release agent 2.

The mineral construction material mixture 3 preferably comprises or consists of concrete, mortar, sand-lime brick, silicate ceramic or a combination thereof. The at least one mineral binder preferably comprises a hydraulic binder, a non-hydraulic binder or a mixture thereof. Further, it is possible for the at least one mineral binder to be selected from the group which consists of calcium silicate hydrates, cement, lime, clay, gypsum, brickearth, magnesia binder and combinations thereof.

In step iii) according to FIG. 2 the mineral construction material mixture 3 at least partially solidifies and a dimensionally stable, mineral green body is obtained. Further, the mineral construction material mixture 3, preferably the dimensionally stable, mineral green body, hardens.

In step iv) it is shown that the mold element 1, preferably the formwork, is removed from the mineral construction material mixture 3. A mineral molded body 4 is obtained.

The release agent 2 preferably cleaves CO₂ from the polymer structure after step i), in step ii) and/or in step iii). In other words, the release agent 2 liberates the CO₂ after and/or during a contact with a mineral construction material mixture 3. The release agent 2 further preferably liberates the CO₂ during an at least partial solidification and/or hardening of the contacted mineral construction material mixture 3.

The decarboxylation of the release agent 2, in particular the porous structure, is preferably initiated by the contact of the release agent 2 with a flowable or plastically deformable mineral construction material mixture 3.

Alternatively or additionally, the release agent 2 can be brought into contact, preferably sprayed and/or doused, with a volume of liquid which contains the above anions and/or cations and is alkaline.

In particular, the flowable or plastically deformable construction material mixture 3 comprises at least one constituent which catalyzes the decarboxylation. The decarboxylation is preferably ionically catalyzed, in particular alkalinically catalyzed. It is possible for the decarboxylation to be thermally catalyzed.

The flowable or plastically deformable construction material mixture 3 preferably contains divalent or polyvalent cations of at least one metal, wherein the at least one metal is preferably selected from the group which consists of Mg, Ca, Sr, Ba, Al, Fe, Co, or mixtures thereof. The cations are preferably present in the form of water-soluble salts.

Di- or polyvalent cations can preferably catalyze the decarboxylation of the polyitaconic acid.

It is possible for a porous matrix of a mineral molded body 4 to be produced, in particular as a first possible mode of action of the liberated CO₂, through the CO₂ at the contact point of the mineral construction material mixture 3 and the surface of the mold element 1, preferably the formwork, on which the release agent 2 is arranged.

It is additionally possible for the chain length and/or polymer mass of the polymer to be reduced through the decarboxylation of the polymer. It is hereby possible for in particular the water-soluble portions of the polymer to diffuse into the mineral construction material mixture 3. The water-soluble portions of the polymer can preferably promote the production of the porous matrix in the mineral molded body.

The porous matrix of the mineral molded body 4 obtained has a lower strength compared with the standard strength of the mineral construction material mixture 3. The adhesive force between formwork and concrete is thus lowered, with the result that the mineral molded body 4 can be easily demolded.

Alternatively or additionally, it is possible, in particular as a second mode of action of the CO₂, that CO₂ reacts at the surface of the mineral construction material mixture 3 to form carbonic acid and, as above, a carbonation takes place for example in the equations (2) to (5). It is hereby possible for the pore volume of the mineral construction material mixture 3 to be reduced and for a boundary surface between the surface of the mold element 1, preferably formwork, to be obtained which has a more uniform and/or smoother surface compared with the mineral construction material mixture 3 before the carbonation and. The contact surface area between the mineral construction material mixture 3 and the surface of the mold element 1, preferably the formwork, can preferably be reduced, which improves the separation of the mold element 1, preferably formwork, from the mineral molded body 4.

It is possible for all of the described modes of action to be present in the production of a mineral molded body 4 and/or for one of the modes of action preferably to be present. The release agent 2 preferably leaves no residues behind on the surface of the mold element 1, preferably on the surface of the formwork. Should residues remain, these can be mechanically removed with water and an ordinary cloth. For example, it is possible for the porous matrix to be obtained on the side of the smoother boundary surface facing the mold element 1, preferably formwork, whereby a particularly good release effect is achieved.

### Example 1

In order to obtain a reactive mixture according to step a), 50 g distilled water was placed in a round-bottomed flask and 15.8 g potassium hydroxide (KOH, Carl Roth, 85%) was dissolved at room temperature (20° C.) with constant stirring. An alkaline pH was reached. 36.65 g itaconic acid (Thermo Scientific Chemicals, 99+%), as carboxylic-acid-containing monomer component, was added slowly to this solution. The solubility of the itaconic acid was improved by the alkaline pH of the solution. Once the itaconic acid had dissolved completely in the solution, 13.35 g acrylamide (Sigma Aldrich, 99+%) was added as a non-carboxylic-acid-containing monomer component. The solution was then flushed with argon for 5 minutes.

After that, the reactive mixture obtained is heated, with stirring, from room temperature to 50° C. and 1.12 g of an initiator is added (Fujifilm Wako Chemicals Europe GmbH, azo polymerization initiator V-50 (radical initiator)). The reactive mixture was obtained according to step a).

The reactive mixture was further heated to 60° C. with further stirring and stirred for 12 hours. After being cooled to room temperature, an aqueous polymer solution was obtained according to step b). The polymer solution had a solids content of 50 wt.-% relative to the dry weight of the polymer solution.

A release agent 2 according to step c) was blended from the polymer solution according to step b). The composition of the release agent 2 corresponded to 1.84 g polymer solution (2 wt.-%), 0.184 g flow additive (1 wt.-%, BYK-Chemie GmbH, Wesel, BYK-Dynwet 800N), 1.38 g thickener (7 wt.-%, Dow Chemical, Midland, Walocell MW 40000) and 90.16 g distilled water (90 wt.-%). The constituents of the release agent 2 were stirred until there was a homogeneous solution.

### Comparison Example

The oil-containing release agent Master Finish RL 419 (MasterBuilders Solutions, Staβfurt) was provided as comparison example.

### Use of the Release Agent

In order to assess the effectiveness and properties of the release agent 2, mineral molded bodies 4 were created. For this, a mold element 1, preferably a formwork, in the form of a plastic cube with an edge length of 150 mm was provided. The release agent 2 according to the invention according to Example 1 and the oil-containing release agent according to the comparison example were deposited on the surfaces of the mold element 1, preferably on the surfaces of the formwork, with a spray gun (Einhell, Landau/Isar) and an application weight of 120 g/m², and then dried.

As mineral construction material mixture 3, 1935 g gravel (grain-size fraction: from 2 mm to 8 mm), 2565 g sand (grain-size fraction: from 0 mm to 2 mm) and 900 g CEM II/A-LL 42.5 N (Portland limestone cement) were mixed with each other and this mixture was stirred with 450 g water to form a homogeneous concrete mixture.

The mineral construction material mixture 3 or the concrete were then poured into the plastic cube. The fill level was at least 9 cm. Only the side parts, i.e. the vertical surfaces of the cube, but not the bottom side, i.e. the horizontal surface, of the cube were used for the analysis.

### Result

A sought molded body surface is characterized in that there are as few shrink holes as possible and/or the shrink holes are as small as possible. The number and size of the shrink holes can be regarded and analyzed as a quality indicator for the molded body surface. The size and number of shrink holes were ascertained as already described further above.

The results are represented in Table 1. It is shown that in the case of the release agent according to Example 1 a much smaller number of shrink holes (holes) was obtained compared with the comparison example and in addition the holes have a much smaller diameter. Further, the absolute surface area of the shrink holes is also reduced. This may possibly be explained in that the oil-containing release agent penetrates into the not yet solidified concrete and thus an increased formation of shrink holes occurs. Further, it is possible for a release agent 2 according to the invention to reduce the size and/or number of shrink holes through carbonation.

TABLE 1
Results of the analysis of the formation of shrink holes
of the release agent according to Example 1 and the
release agent according to the comparison example

| Release agent | Example 1 | Comparison example |
|---|---|---|
| Surface area | 1144 | 7797 |
| of holes/Pixels | | |
| Surface area | 0.311 | 2.024 |
| of holes/% | | |
| Surface area | 0.375 | 2.553 |
| of holes/cm² | | |
| Total surface | 120.53 | 126.15 |
| area of | | |
| sample/cm² | | |
| Number of holes/— | 312 | 905 |
| Diameter of holes/ | 3.667 | 8.615 |
| Pixels | | |
| Holes per surface | 2.59 | 7.17 |
| area/1/cm² | | |

The cleanness of the formwork surface is an important point as it reveals how much effort is needed to clean the surface of the mold element 1 after the mineral molded body 4 has been demolded. In order to find out how clean the surfaces of the cubic mold elements 1 used are, they were wiped with a moist cloth. The residue of the release agent 2 according to Example 1 was able to be removed easily with the cloth, while the release agent of the comparison example remained behind on the surface of the mold element 1.

The dusting, i.e. the detachment of fine particles from a mineral molded body surface because of low structural bonding, of the molded body surfaces was checked with an adhesive tape (Tesa) by means of an adhesion test. In the adhesion test, a Tesa film 4104 with a width of 14 mm is used, which is pressed onto the molded body surface bubble-free by spreading three times with the tip of the thumb. After the spreading, the Tesa film is rapidly peeled away from the molded body manually at an angle of from 45° to 60°. The angle is measured in particular between the planes formed by the Tesa film. The adhesive tape was then applied in turn to a piece of white paper in order to ascertain the degree of dusting visually. It was shown that the adhesive tape which from the molded body surface which was obtained by the release agent according to Example 1 a smaller quantity of particles was visually perceptible, compared with the molded body surface which was obtained by the release agent of the comparison example. This can possibly be explained by a penetration of the oil-containing release agent into the mineral construction material mixture 3, which here leads to setting failures and structural failures. Further, it is possible for a smoother surface boundary, which can be described by way of example as a type of skin, to be obtained through a release agent 2 according to the invention.

In summary, through the method according to the invention it is possible to provide an improved release agent 2, which has an improved environmental compatibility on the one hand and a good release agent action on the other.

Of course, the listed embodiment variants can be combined with each other as desired and do not represent a limitation.

### LIST OF REFERENCE NUMBERS

1 mold element
2 release agent
2′ release agent with decarboxylated polymer
3 mineral construction material mixture
4 mineral molded body

1. A method for producing a release agent, wherein the method comprises at least the following steps:
a) providing a reactive mixture, comprising a carboxylic-acid-containing monomer component, which comprises itaconic acid and/or itaconic acid derivatives,
b) polymerizing the reactive mixture to form a polymer solution, wherein the polymer solution comprises a polymer which is at least partially dissolved in a solvent and which contains the carboxylic-acid-containing monomer component,
c) obtaining a release agent comprising the polymer solution, wherein CO₂ can be liberated from the release agent by decarboxylation.

2. The method according to claim 1, wherein the polymer solution and/or the release agent comprise and/or consist of biogenic constituents and/or are biodegradable and/or compostable.

3. The method according to claim 1, wherein the release agent forms the CO₂ after arrangement on at least one surface of a mold element.

4. The method according to claim 1, wherein the carboxylic-acid-containing monomer component of the reactive mixture contains, besides itaconic acid and/or itaconic acid derivatives, at least one further carboxylic-acid-containing monomer component, which is selected individually or in combination from the group which consists of acrylic acid, methacrylic acid, fumaric acid and maleic acid.

5. The method according to claim 1, wherein the proportion of monomer of the carboxylic-acid-containing monomer component, relative to the total mass of the reactive mixture, is selected from a range of from 2.5 wt.-% to 65 wt.-%.

6. The method according to claim 1, wherein the reactive mixture contains at least one non-carboxylic-acid-containing monomer component which is selected individually or in combination from the group which consists of acrylamide, esters of acrylic acid, esters of methacrylic acid, esters of itaconic acid, esters of maleic acid, maleic acid anhydride, terpenes and/or combinations thereof.

7. The method according to claim 1, wherein the proportion of monomer of the non-carboxylic-acid-containing monomer component, relative to the total mass of the reactive mixture, is selected from a range of from 5 wt.-% to 50 wt.-%.

8. The method according to claim 1, wherein the carboxylic-acid-containing monomer component and/or the non-carboxylic-acid-containing monomer component comprise and/or consist of biogenic constituents, and/or are biodegradable and/or are compostable.

9. The method according to claim 1, wherein the reactive mixture contains a solvent which is selected individually or as mixtures from the group which consists of ethanol, 1-propanol, 2-propanol, acetone, 2-butanone (MEK), acetate.

10. The method according to claim 1, wherein the reactive mixture contains a solvent which comprises and/or consists of water.

11. The method according to claim 1, wherein the proportion of the solvent, relative to the total mass of the reactive mixture, is selected from a range of from 15 wt.-% to 95 wt.-%.

12. The method according to claim 1, wherein the reactive mixture comprises an initiator.

13. The method according to claim 12, wherein the proportion of the initiator, relative to the total mass of the reactive mixture, is selected from a range of from 0.05 wt.-% to 1.5 wt.-%.

14. The method according to claim 12, wherein the initiator is selected from the group which consists of azo compounds, peroxides or mixtures thereof.

15. The method according to claim 1, wherein step b) is carried out at a temperature of the reactive mixture selected from a range of from 20° C. to 110° C.

16. The method according to claim 1, wherein the solvent of the polymer solution comprises and/or substantially consists of water.

17. The method according to claim 1, wherein the polymer is water-soluble.

18. The method according to claim 1, wherein the polymer contains the carboxylic-acid-containing monomer component selected from a range of from 25 wt. % to 100 wt. %.

19. The method according to claim 1, wherein the polymer contains the non-carboxylic-acid-containing monomer component, selected from a range of from more than 0 wt.-% to 75 wt.-%.

20. The method according to claim 1, wherein the polymer contains an initiator, selected from a range of from 0.05 wt.-% to 2 wt.-%.

21. The method according to claim 1, wherein the polymer has a value for a glass transition temperature which is selected from a range of from −20° C. to 110° C.

22. The method according to claim 1, wherein CO₂ can be liberated from the release agent independently of its moisture content.

23. The method according to claim 1, wherein the release agent contains an indicator, whereby the release agent in a dry state has a different color impression compared with a moist state.

24. The method according to claim 23, wherein the indicator has a color impression in the moist state of the release agent and the indicator is colorless in the dry state of the release agent.

25. The method according to claim 23, wherein the indicator is selected from one or more leuco dyes.

26. The method according to claim 1, wherein the release agent comprises a flow additive.

27. The method according to claim 1, wherein the release agent comprises a thickener.

28. The method according to claim 1, wherein the release agent comprises the polymer solution selected from a range of from 0.01 wt.-% to 100 wt.-%.

29. The method according to claim 1, wherein the solvent of the release agent comprises and/or substantially consists of water.

30. The method according to claim 1, wherein the release agent comprises solvent selected from a range of from more than 0 wt.-% to 99.99 wt.-%.

31. The method according to claim 1, wherein the release agent has a dynamic viscosity which is selected from a range of from 1 mPas to 300 Pas.

32. The method according to claim 1, wherein the release agent contains no dispersion additive and/or emulsion additive and/or wherein the release agent contains no polychlorinated biphenyls and/or wherein the release agent contains no refined oils and/or fats, biogenic oils and/or fats.

33. The method according to claim 1, wherein, after an the at least partial solidification and/or a hardening of a mineral molded body, the surface of the a mineral molded body brought into contact with the release agent is designed such that the surface area of holes and/or shrink holes, relative to the total surface area, is less than 5%.

34. The method according to claim 1, wherein the decarboxylation of the release agent is initiated by the contact of the release agent with a flowable or plastically deformable mineral construction material mixture.

35. The method according to claim 1, wherein the decarboxylation is ionically catalyzed.

36. A release agent comprising a polymer at least partially dissolved in a solvent, wherein the polymer contains a carboxylic-acid-containing monomer component which comprises itaconic acid and/or itaconic acid derivatives,
and wherein CO₂ can be liberated from the release agent by decarboxylation.
